(19) United States
(12) Patent Application Publication
(10) Pub. No.: US 2010/0082433 A1
(43) Pub. Date: Apr. 1, 2010

(54) Using A Threshold Function For Bidding In Online Auctions

(76) Inventors: Yunhong Zhou, Cupertino, CA (US); Victor Naroditskiy, Providence, RI (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/243,147

(22) Filed: Oct. 1, 2008

(51) Int. Cl. G06Q 30/00

(52) U.S. Cl. 705/14.54; 705/1

(57) ABSTRACT

One embodiment is a method that generates bids at an online search auction. The method uses a threshold function to decide which slot to obtain and bids accordingly.

### RELATED CO-PENDING APPLICATION

This application relates to co-pending U.S. patent application having Ser. No. 11/830,698, entitled “Bidding in Online Auctions” filed on Jul. 30, 2007 and being incorporated herein by reference.

### BACKGROUND

Search engines provide a popular tool for searching keywords over the Internet. Search engines and corresponding online sponsored search auctions globally generate billions of dollars a year in revenue. The search engine results page (SERP) of a keyword search is therefore an effective place for advertisers to market to potential customers

Using an automated auction mechanism, search engines sell the right to place ads next to keyword results and alleviate the auctioneer from the burden of pricing and placing ads. The intent of the consumer is matched with that of the advertiser through an efficient cost/benefit engine that favors advertisers who offer what consumers seek.

On the advertising side, large companies spend billions of dollars each year in marketing with an increasingly large portion of that money dedicated to search engine marketing. Since such large sums of money are being spent, advertisers strive to maximize return of investments (ROI) for themselves while strategically bidding against competing advertisers.

### BRIEF DESCRIPTION OF THE DRAWINGS

FIG. 1 illustrates an exemplary data processing network in accordance with an exemplary embodiment.

FIG. 2 illustrates an exemplary search engine and bid optimization engine in accordance with an exemplary embodiment.

FIG. 3 illustrates an exemplary flow diagram in accordance with an exemplary embodiment.

### DETAILED DESCRIPTION

Exemplary embodiments are directed to systems, methods, and apparatus for budget constrained bidding in online keyword auctions. Exemplary embodiments optimize bids for advertisers bidding in a competitive environment for advertising slots in an online auction.

One embodiment is directed to sponsored search auctions hosted by search engines that allow advertisers to select relevant keywords, allocate budgets to those terms, and bid on different advertising positions for each keyword in a real-time auction against other advertisers. Exemplary embodiments provide optimal bid management of advertising budgets, especially for large advertisers who need to manage thousands of keywords and spend tens of millions on such advertising.

In one embodiment, optimization of bid management is cast as an online Multiple-Choice Knapsack Problem (online MCKP) and corresponding algorithms for the online knapsack problem, and exemplary embodiments solve this problem and a corresponding keyword bidding problem. Specifically, exemplary embodiments are based on selecting items online according to a threshold function that is built using historical data and updated online. Experimental results with synthetic data generated from different distributions and a real bidding dataset show that exemplary embodiments achieve a 99% performance compared to an offline optimal solution.

One exemplary embodiment models the budget constrained bidding problem for keyword auctions as the online MCKP, provides a method for the online MCKP, and translates it back to solve the budget-constrained bidding problem. The method for keyword bidding as well as the online MCKP assumes input item-sets are independently and identically distributed (iid). Exemplary methods, however, do not require any knowledge of the distribution. Instead, exemplary methods are based on maintaining a threshold function. This threshold function can be built in advance using historical training dataset, or can be built from scratch and updated overtime during the execution of the algorithm. The machine learning capability improves the bidding performance and makes exemplary methods more attractive to field deployment.

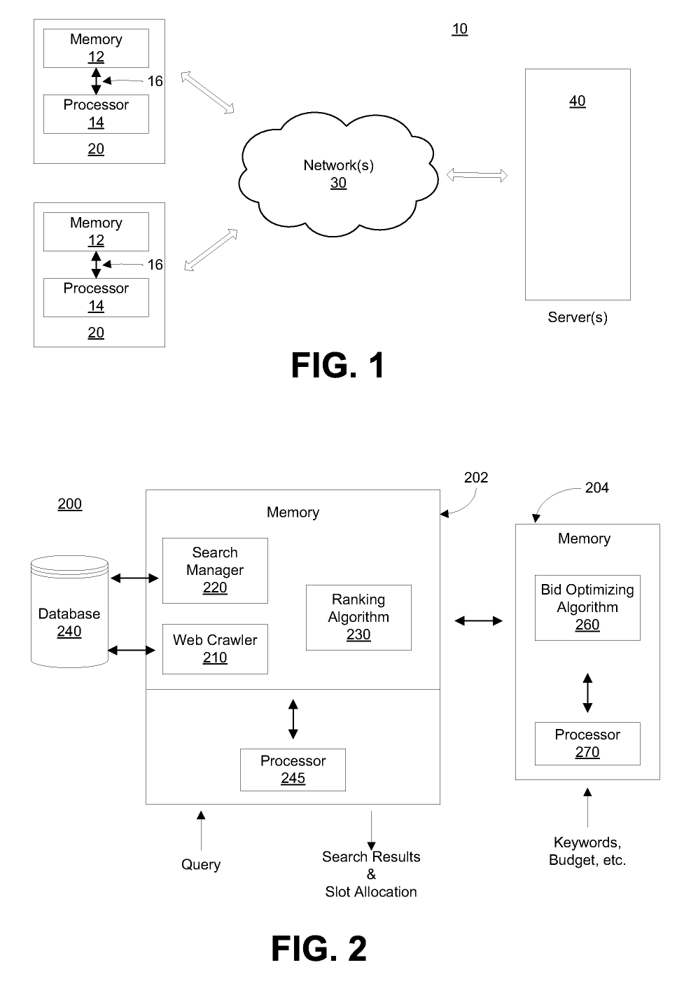

FIG. 1 illustrates an exemplary system or data processing network 10 in which exemplary embodiments are practiced. The data processing network includes a plurality of computing devices 20 in communication with a network 30 that is in communication with one or more computer systems or servers 40.

For convenience of illustration, only a few computing devices 20 are illustrated. The computing devices include a processor 12, memory 14, and bus 16 interconnecting various components. Exemplary embodiments are not limited to any particular type of computing device or server since various portable and non-portable computers and/or electronic devices may be utilized. Exemplary computing devices include, but are not limited to, computers (portable and non-portable), laptops, notebooks, personal digital assistants (PDAs), tablet PCs, handheld and palm top electronic devices, compact disc players, portable digital video disk players, radios, cellular communication devices (such as cellular telephones), televisions, and other electronic devices and systems whether such devices and systems are portable or non-portable.

The network 30 is not limited to any particular type of network or networks. The network 30, for example, can include one or more of a local area network (LAN), a wide area network (WAN), and/or the Internet or intranet, to name a few examples. Further, the computer system 40 is not limited to any particular type of computer or computer system. The computer system 40 may include personal computers, mainframe computers, gateway computers, and application servers, to name a few examples.

Those skilled in the art will appreciate that the computing devices 20 and computer system 40 connect to each other and/or the network 30 with various configurations. Examples of these configurations include, but are not limited to, wireline connections or wireless connections utilizing various media such as modems, cable connections, telephone lines, DSL, satellite, LAN cards, and cellular modems, just to name a few examples. Further, the connections can employ various protocols known to those skilled in the art, such as the Transmission Control Protocol/Internet Protocol (“TCP/IP”) over a number of alternative connection media, such as cellular phone, radio frequency networks, satellite networks, etc. or UDP (User Datagram Protocol) over IP, Frame Relay, ISDN (Integrated Services Digital Network), PSTN (Public Switched Telephone Network), just to name a few examples. Many other types of digital communication networks are also applicable. Such networks include, but are not limited to, a digital telephony network, a digital television network, or a digital cable network, to name a few examples. Further yet, although FIG. 1 shows one exemplary data processing network, exemplary embodiments can utilize various computer/network architectures.

For convenience of illustration, an exemplary embodiment is illustrated in conjunction with a search engine. This illustration, however, is not meant to limit embodiments with search engines. Further, exemplary embodiments do not require a specific search engine. The search engine can be any kind of search engine now known or later developed. For example, exemplary embodiments are used in conjunction with existing search engines (such as Google™ and variations thereof) or search engines developed in the future.

FIG. 2 illustrates an exemplary system 200 that includes a search engine 202 and bid optimization engine 204. As one example, the search engine 202 and bid optimization engine 204 are programs stored in the memory of computer system 40. The search engine enables a user to request information or media content having specific criteria. The request, for example, can be entered as keywords or a query. Upon receiving the query, the search engine 202 retrieves documents, files, or information relevant to the query. The bid optimization engine 204 optimizes bids for advertising slots when the search results are displayed to a user.

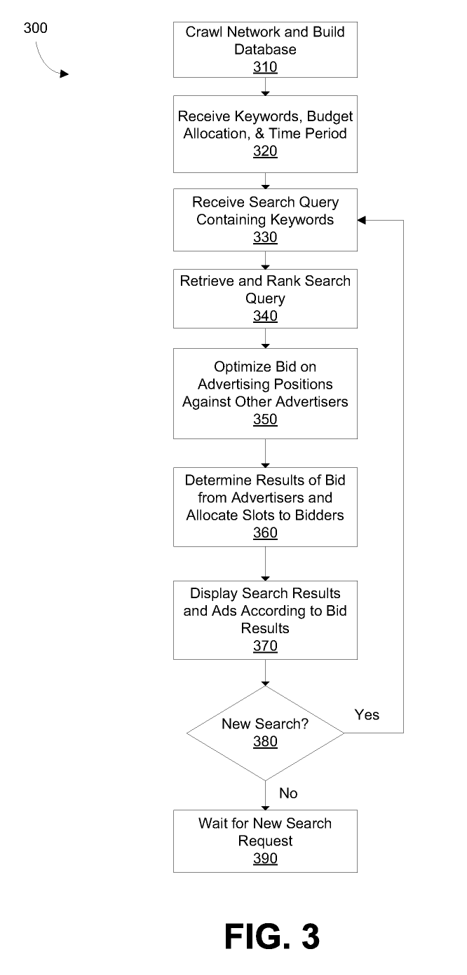

For simplicity of illustration, the search engine 202 includes a web crawler 210, a search manager 220, and a ranking algorithm 230 coupled to one or more processors 245 and a database 240. The bid optimization engine 204 includes a bid optimizing algorithm 260 coupled to one or more processors 270. The search engine 202 and bid optimization engine 204 are discussed in connection with the flow diagram 300 of FIG. 3.

According to block 310, the web crawler 210 crawls or searches the network and builds an associated database 240. The web crawler 210 is a program that browses or crawls networks, such as the Internet, in a methodical and automated manner in order to collect or retrieve data for storage. For example, the web crawler can keep a copy of all visited web pages and indexes and retain information from the pages. This information is stored in the database 240. Typically, the web crawler traverses from link to link (i.e., visits uniform resource locators, URLs) to gather information and identify hyperlinks in web pages for successive crawling.

One skilled in the art will appreciate that numerous techniques can be used to crawl a network, and exemplary embodiments are not limited to any particular web crawler or any particular technique. As one example, when web pages are encountered, the code comprising each web page (e.g., HyperText Markup Language or HTML code) is parsed to record its links and other page information (for example, words, title, description, etc.). A listing is constructed containing an identifier (for example, web page identifier) for all links of a web page. Each link is associated with a particular identifier. The listing is sorted using techniques known in the art to distinguish the web pages and respective links. The relationship of links to the parsed web pages and the order of the links within a web site are maintained. After sufficient web sites have been crawled, the recorded or retrieved information is stored in the database 240.

Once the database 240 is created, the search engine 202 can process search queries and provide search results. One skilled in the art will appreciate that numerous techniques can be used to process search queries and provide search results, and exemplary embodiments can be utilized with various techniques.

According to block 320, the bid optimization engine 204 receives information from an advertiser concerning the placement of ads for online auctions. By way of example, this information includes, but is not limited to, one or more of keywords, a budget, and a time period for utilizing the budget.

By way of example, suppose there are N+1 bidders {0, . . . ,N} interested in a single keyword. Bidder 0 is the default advertiser, and he wants to maximize his profit over a period of time T. Let V denote the expected value-per-click for the default advertiser, and he has a budget of B over time period T (e.g. if T is 24 hours, B is the daily budget). Here the budget constraint is a hard constraint, in the sense that once exhausted, it cannot be refilled; budget remaining at the end of the period T is taken away. Once a bidder exhausts his budget, he leaves the auction.

According to block 330, the search manager 220 receives a query (such as keywords) from a user or computing device (such as computing device 20 in FIG. 1). The search manager 220 can perform a multitude of different functions depending on the architecture of the search engine. By way of example and not to limit exemplary embodiments, the search manager 220 tracks user sessions, stores state and session information, receives and responds to search queries, and coordinates the web crawler and ranking algorithm, to name a few examples.

According to block 340, the search engine retrieves and ranks the search query. By way of example, the search engine 202 accesses the database 240 to find or retrieve information that correlates to the query. As an example, the search manager 220 could retrieve from the database 240 all web sites that have a title and description matching keywords in the query. The search manager 220 then initiates the ranking algorithm 230 to score and rank the information (for example, the retrieved web sites) retrieved from the database 240.

According to block 350, the bid optimization engine 204 optimizes bids on advertising positions against other advertisers. Generally, for each keyword and each time period, exemplary embodiments determine how much money an advertiser should bid to obtain a slot or advertising position on the search results page in order to maximize return on investment (ROI).

In one embodiment, for each user click on its ad, the advertiser obtains revenue that is the expected value-per-click and a profit that is equal to the difference between revenue and cost. The advertiser (or the agent on behalf of the advertiser) has a budget constraint and would like to maximize either the revenue or the profit. These budget constraints arise out of the ordinary operational constraints of the firm and its interactions with its partners, as well as being a generic feature of keyword auction services themselves.

One embodiment uses competitive analysis to evaluate bidding strategies and compares results with the maximum profit attainable by the omniscient bidder who knows the bids of all the other users ahead of time. This competitive analysis framework has been used in the worst-case analysis of online algorithms and helps to convert the problem of devising bidding strategies to designing algorithms for online knapsack problems. While the most general online knapsack problem admits no online algorithms with any non-trivial competitive ratio, the auction scenario suggests a few constraining assumptions that enable exemplary embodiments to provide optimal online algorithms.

According to block 360, a determination is made of the results of the bid from advertisers and slots are allocated to the bidders. By way of example, the bidding strategies in accordance with exemplary embodiments are based on the current policy used by search engines to display their ads. For instance, embodiments assume that at each query of a keyword, the highest bidder gets first position, the second highest gets the second position and so on. Moreover, the pricing scheme is the generalized second price scheme where the advertiser in the i-th position pays the bid of the (i+1)-th advertiser whenever the former's ad is clicked on.

In one embodiment, bidders bid on the keyword, and are allowed to change their bids at any moment of time. One assumption is that the bids are very small compared to the budget of Bidder 0. As soon as a query for the keywords arrives, the search engine allocates S slots to bidders as follows: It takes the S highest bids, b₁≧b₂≧ . . . ≧bₛ and displays s-th bidder's ad in slot s. Moreover, if any user clicks on the ad at the s-th slot, the search engine charges the s-th bidder a price bₛ₊₁, if s<S or a minimum fee bₘᵢₙ(for example, 10¢). Hence, it can be assumed that all the bids are at least bₘᵢₙ.

Each slot s has a click-through rate α(s), which is defined as the expected number of clicks on an ad divided by the total number of impressions (displays). Usually α(s) is a decreasing function of s. Each time his ad in slot s is clicked, Bidder 0 gets a profit of V−bₛ₊₁ where bₛ₊₁ is the bid of the advertiser in the (s+1)-th slot or bₘᵢₙ if s=S. Suppose the time interval T is discretized into periods {1,2, . . . , T}, such that, within a single time period t, no bidder changes his bid. Let X(t) denote the expected number of queries for the keyword in time period t. Moreover, suppose Bidder 0 can make his bid in time period t after seeing all other bidders' bids. This assumption does not matter much and is mainly for explanation purposes. The problem faced by Bidder 0 is to decide, how much to bid at each time period t in order to maximize its profit while keeping its total cost within its budget.

According to block 370, the ranked information is then displayed to the user or provided to the computing device. Further, the ads are displayed with the search results according to the bid results. The information is displayed, for example, in a hierarchical format with the most relevant information (for example, webpage with the highest score) presented first and the least relevant information (for example, webpage with the lowest score) presented last. The ads are displayed according to the winning bids (i.e., the ad with the highest bid being displayed first, the ad with the next highest bid being displayed second, etc.).

If a modified or new search is requested, according to block 380, then the flow diagram loops back to block 330; otherwise, the flow diagram waits for new search requests 390.

Exemplary embodiments are further described below with headings provided for various sections.

Online Knapsack Problems and Lueker's Algorithm

The 0/1 Knapsack Problem (KP) is as follows: given a set of items {(wᵢ, vᵢ)|1≦i≦n} and a knapsack capacity C, select a subset of items to maximize the total value of selected items while the total weight is bounded by C. For each item i, we call wᵢ its weight, vᵢ its value, and the ratio between value and weight its efficiency (eᵢ=vᵢ/wᵢ). The Online Knapsack Problem (Online-KP) is the same as the 0/1 KP except that items arrive online one at a time. At each time period t, item t arrives, and the algorithm has to decide whether to select item t or not. The Stochastic Online-KP is the same as Online-KP with an extra assumption that the (weight, value) pair of each item is randomly drawn from the same joint distribution. Naturally, we assume that the knapsack capacity is proportional to the number of items (C=Θ(n)), and all items are small compared to the overall knapsack capacity (wₜ=O(1) and vₜ=O(1), ∀t). Lueker's Algorithm for the Stochastic Online-KP is based on a threshold function that is generated using the distribution of items. All items are assumed to be independently and identically distributed (iid). Only items with efficiency at least the threshold efficiency are included in the solution. The algorithm for Online-KP is shown below:

$$Algorithm ALG \text{-} Lueker \text{-} OKP$$

$$Input \text{:} items ( {w}_{t} , {v}_{t} ) for t = 1 , … , n ;$$

$$knapsack capacity C ;$$

$$threshold function g = {f}^{1}$$

$$Output \text{:} items to take$$

$$1. for each item t from 1 to n$$

$$if {e}_{t} \geq g ( \frac{C}{n - t + 1} ) and {w}_{t} \leq C$$

$$take item t$$

$$C := C - {w}_{t}$$

$$2. return items taken .$$

The Threshold Function

One part of an exemplary method is the threshold function g which maps the average remaining capacity per time period to an efficiency value, denoted threshold efficiency. The threshold efficiency (denoted by e* in the equation below) is such that the expected weight of the remaining items with efficiency at least the threshold efficiency is equal to the remaining capacity as follows:

$$\begin{matrix}C = {E}_{\{ ( {w}_{j} , {v}_{i} ) \}} [ {\sum }_{i = 1}^{n} {w}_{i} \cdot {1}_{\{ {e}_{i} \geq {e}^{*} \}} ] \\ = {\sum }_{i = 1}^{n} {E}_{\{ ( {w}_{i} , {v}_{i} ) \}} [ {w}_{i} \cdot {1}_{\{ {e}_{i} \geq {e}^{*} \}} ] .\end{matrix}$$

The second equality above uses the linearity of expectation. Since all items are iid, thus the follows:

$$\begin{matrix}C = {\sum }_{i = 1}^{n} {E}_{\{ ( {w}_{i} , {v}_{i} ) \}} [ {w}_{i} \cdot {1}_{\{ {e}_{i} \geq {e}^{*} \}} ] \\ = n {E}_{( w , v )} [ w \cdot {1}_{\{ v / w \geq {e}^{*} \}} ]\end{matrix}$$

$$\frac{C}{n} = {E}_{( w , v )} [ w \cdot {1}_{\{ v / w \geq {e}^{*} \}} ]$$

Then let the following:

f(e)≡E_{(w,v)}[w 1_{{v/w≧e}}] (Eqn. 1)

then the threshold function is g=ƒ⁻¹, the inverse of f. Here, ƒmaps the threshold efficiency e to the expected item weight among items with efficiency at least e, while g maps the average capacity per item to the efficiency threshold.

Approximation Methods for Online-MCKP

Next, we describe a method of an exemplary embodiment for Stochastic Online-MCKP. Before we introduce the method, we first define the problem briefly. The Multiple-Choice Knapsack Problem is a generalization of the 0/1 KP: Given a collection of item-sets {Nₜ|t=1, . . ., n} where Nₜ={(wₜᵢ, vₜᵢ|1≦i≦nₜ} for each t and a knapsack capacity C, select at most one item from each item-set to maximize the total value of selected items while the total weight of selected items is bounded by C. The Online MCKP is the online version of MCKP where item-set N, arrives at time t and the algorithm needs to select at most one item from Nₜ. Stochastic Online-MCKP is the same as Online-MCKP with an extra assumption that all item-sets are iid random variables. Naturally we assume C=Θ(n), wₜᵢ=O(1), vₜᵢ=O(1)∀t, i. In one embodiment, the method for the Stochastic Online-MCKP is partially based on Lueker's Algorithm for Stochastic Online-KP and an approximation for MCKP. We first describe the approximation for MCKP, then an approximation for the threshold function, and finally the overall algorithm.

An Approximation Algorithm for MCKP

Approximation for MCKP modifies the items from each item-set so that taking multiple items is equivalent to taking one original item. An item i is dominated by another item j if wⱼ≦wᵢ and vᵢ<vⱼ. An item i is LP-dominated by items j and k if i is dominated by a convex combination of j and k. Equivalently, if Wⱼ<wᵢ<wₖ and vⱼ<vᵢvₖ, then i is LP-dominated by j, k if:

$$\frac{{v}_{k} - {v}_{i}}{{w}_{k} - {w}_{i}} \geq \frac{{v}_{i} - {v}_{i}}{{w}_{i} - {w}_{i}} .$$

The method to remove all dominated and LP-dominated items and generate incremental items is shown below. The algorithm consists of two steps, first sorting items in increasing weight order, then removing dominated and LP-dominated items repeatedly. The second step clearly takes linear time, thus the total running time is dominated by the first step of sorting, thus O(n log n) time.

The following algorithm generates incremental items from an item-set:

$$Algorithm ALG \text{-} Gen \text{-} Incr \text{-} Items$$

$$Input \text{:} an item \text{-} set {N}_{t} = \{ ( {w}_{ti} , {v}_{ti} ) \vert i = 1 , … , {n}_{t} \}$$

$$Output \text{:} incremental items$$

$$1. sort items according to increasing weights$$

$$2. {/}^{**} remove dominated and LP \text{-} dominated items {/}^{**} \\ let Q be a queue with intially one element ( 0 , 0 )$$

$$for i from 1 to {n}_{t}$$

$$push element i into the queue$$

$$( l always denote the last element of Q )$$

$$if {w}_{l} = {w}_{l - 1}$$

$$remove from Q either item l or l - 1 with smaller value$$

$$while l > 2 and \frac{{v}_{l - 1} - {v}_{l - 2}}{{w}_{l - 2} - {w}_{l - 2}} \leq \frac{{v}_{l} - {v}_{l - 1}}{{w}_{l} - {w}_{l - 1}}$$

$$remove item l - 1 from Q$$

$$3. {/}^{**} create incremental items from items in Q$$

$$let \{ ( {w}_{i} , {v}_{i} ) \vert 1 \leq i \leq 1 \} denote the items in Q$$

$${\overline{w}}_{1} = {w}_{1} , {\overline{v}}_{1} = {v}_{1}$$

$${\overline{w}}_{i} = {w}_{i} - {w}_{i - 1} , {\overline{v}}_{i} = {v}_{i} - {v}_{i - 1} , 1 \leq i \leq l . \\ 4. return \{ ( {\overline{w}}_{i} , {\overline{v}}_{i} ) \vert 1 \leq i \leq 1 \} .$$

Once all dominated and LP-dominated items are removed, remaining items are sorted in increasing weight order, then for three adjacent items i−1, i, i+1, we have the following:

$$\begin{matrix}\frac{{v}_{i} - {v}_{i - 1}}{{w}_{i} - {w}_{i - 1}} = \frac{{\overline{v}}_{i}}{{\overline{w}}_{i}} \\ = {\overline{e}}_{i} \geq \frac{{v}_{i + 1} - {v}_{i}}{{w}_{i + 1} - {w}_{i}} \\ = \frac{{\overline{v}}_{i + 1}}{{\overline{w}}_{i + 1}} \\ = {\overline{e}}_{i + 1} .\end{matrix}$$

Thus the efficiency of incremental items are monotone decreasing: ē₁>ē₂> . . . >ē₁. Taking incremental items 1, . . . , i in set Q is equivalent to taking item i in set Q, which corresponds to an original item in Nₜ.

Next we describe the approximation algorithm for MCKP, shown in the algorithm below. The algorithm ALG-MCKP-Greedy relies on the fact that, for any t, it will select the first i incremental items, which corresponds to selecting item i in Rₜ, thus an original item in Nₜ. So ALG-MCKP-Greedy computes a valid solution. One can actually prove that the algorithm gives a near optimal approximation to MCKP.

The following provides the approximate algorithm for MCKP:

$$Input \text{:} item \text{-} set {N}_{t} for t = 1 , … , n ;$$

$$knapsack capacity C$$

$$Output \text{:} items selected , at most one from each item \text{-} set , \\ with total weight at most C$$

$$1. for t from 1 to n$$

$$generate incremental items from {N}_{t} using ALG \text{-} Gen \text{-} Iner \text{-} Items$$

$$2. let S denote the collection$$

$$of all incremental items for all item \text{-} set sort S according to$$

$$decreasing efficiency ( value / weight )$$

$$3. select incremental items immediately before$$

$$the total weight exceeds C$$

$$4. reconstruct original items from the selected incremental items$$

Approximating the threshold function

To compute an approximate solution for Online-MCKP, we first convert each item set into a set of incremental items, and try to apply Lueker's Algorithm for Online-KP to these incremental items. Lueker's algorithm requires the threshold function as an input, where is not available to us. In this section we discuss how to compute an approximate threshold function using sample item-sets, and how to update the threshold function over time.

Generating threshold function from a sample

Given a set of training item-sets, we can transform them into a collection of incremental items. The distribution of incremental items may not be known or have a closed-form representation, however we can approximate it if we have a reasonably large sample size.

Given a sample set of m incremental items, we can approximate the threshold function given by Eq. 1 with the average over all the sample points. Formally, we can use \tilde{ƒ} to approximate f where:

$$\tilde{f} ( e ) = \frac{l}{m} {\sum }_{i = 1}^{m} {w}_{i} {l}_{{e}_{i} \geq e} . \qquad ( Eqn . 2 )$$

Assuming that eᵢ=vᵢ/wᵢ are sorted in decreasing order, then ∀ e ∈ (eᵢ₊₁, eᵢ], \tilde{ƒ}(e) is equal to w̅ᵢ≡(w₁+ . . . +wᵢ)/m. Therefore \tilde{ƒ} is a piecewise constant function, and it can be represented as a sorted list of pairs {(eᵢ, w̅ᵢ)|1≦i≦m} where {eᵢ} monotone decreasing and { w̅ᵢ} monotone increasing.

The threshold function can be computed using the algorithm as shown below:

$$Algorithm ALG \text{-} Gen \text{-} Threshold \\ Input \text{:} set of incrementals items \{ ( {w}_{j} , {v}_{j} ) \} \vert j = 1 , … , m \}$$

$$Output \text{:} approximate threshold function f$$

$$1. sort items in decreasing order of efficiency . \\ let {e}_{j} = {v}_{j} / {w}_{j} , {∀}_{j} , then {e}_{1} \leq {e}_{2} \leq … \leq {e}_{m} \\ 2. f ( {e}_{1} ) = \frac{{w}_{1}}{m} \\ 3. f ( {e}_{j} ) = f ( {e}_{j - 1} ) + \frac{{w}_{j}}{m} , ∀ 1 < j \leq m \\ 4. return f .$$

Update Threshold Function Online

We can update the threshold function as we are presented with new sets of incremental items. It is convenient to represent the threshold function by a collection of efficiencies e₁>e₂> . . . >eₖ sorted in decreasing order and a collection of corresponding weights w₁<w₂< . . . <wₖ in increasing order where wᵢ=f(eᵢ). Initially the collections can be empty in which case the threshold function is generated using the first item-set. The algorithm below shows updating the threshold function:

$$Algorithm ALG \text{-} Update \text{-} Threshold$$

$$Input \text{:} threshold function f = \{ ( {e}_{i} , {w}_{i} ) \vert 1 \leq i \leq k \} , \\ a set of incremental items \{ ( {\overline{w}}_{j} , {\overline{v}}_{j} ) \vert 1 \leq j \leq m \}$$

$$Output \text{:} updated \overline{f}$$

$$1. {/}^{**} normalize weights { }^{**} / \\ {w}_{i} := {w}_{i} \frac{k}{k + m} , 1 \leq i \leq k . \\ {\overline{w}}_{j} := {\overline{w}}_{j} \frac{1}{k + m} , 1 \leq j \leq m . \\ 2. {/}^{**} update weights {}^{ **} / \\ {w}_{i} := {w}_{i} + {\sum }_{{\overline{e}}_{j} \geq {e}_{i}} {\overline{w}}_{j} , 1 \leq i \leq k . \\ 3. {/}^{**} create a new list of sorted ( e , w ) pairs {}^{**} / \\ for j from 1 to m$$

$$if there is no pair in f with efficiency {\overline{e}}_{j} = \frac{{\overline{v}}_{j}}{{\overline{w}}_{j}}$$

$$i = arg {max}_{i} \{ {e}_{i} \geq {\overline{e}}_{j} \}$$

$$add ( {\overline{e}}_{j} , {w}_{i} + {w}_{j} ) to the new list of pairs$$

$$4. linearly merge the new list and \overline{f} to get the updated \overline{f} .$$

An Approximation Algorithm for Online MCKP

We are now ready to describe our algorithm for Online-MCKP. For each item-set arriving online, we use ALG-Gen-Incr-Items given above to generate incremental items for the item-set and use the approximate threshold function to select incremental items for the current time period. Since we described how to generate the approximate threshold function and update it, we are now ready to describe the whole algorithm.

The algorithm for Online-MCKP is shown below. It consists of two phases, where the first is optional, and it depends on whether training item-sets are available. For the second phase, the algorithm decides whether or not to select an item at time period t using the threshold function, and updates the threshold function if necessary.

$$Algorithm ALG \text{-} Online \text{-} MCKP$$

$$Input \text{:} item \text{-} set {N}_{t} for t = 1 , … , n ;$$

$$knapsack capacity C ;$$

$$( optional ) training item \text{-} sets$$

$$1. ( optional ) {/}^{**} generate threshold function f from training$$

$$item sets {}^{**} / \\ create incremental items from training item \text{-} sets using$$

$$ALG \text{-} Gen \text{-} Incr \text{-} Items$$

$$r is the average number of incremental items per item \text{-} set$$

$$generate f using ALG \text{-} Gen \text{-} Threshold with these incremental$$

$$items as input$$

$$2. for t from 1 to n$$

$$create incremental items from item \text{-} set {N}_{t} using$$

$$ALG \text{-} Gen \text{-} Incr \text{-} Items$$

$$( optional step ) update f ( using ALG \text{-} Update \text{-} Threshold ) and r$$

$$e = {f}^{- 1} ( \frac{C}{r ( n - t + 1 )} ) \\ {/}^{**} r ( n - t + 1 ) is the expected number of remaining incr . \\ items ** / select incremental items with efficiency at least e$$

$$\overline{w} , \overline{v} are the total weight and value of selected$$

$$incremental \text{-} items$$

$$if w \leq C$$

$$take item ( \overline{w} , \overline{v} )$$

$$C := C - \overline{w} .$$

Keyword Bidding as Online-MCKP

Sponsored search auctions are used by search engine companies to sell ad positions to advertisers on search results page, where popular query terms are treated as “keywords”. An auction is set up for each keyword where advertisers submit bids and compete for different ad positions. The auction mechanism determines how to rank and price ads, using factors like the bidding prices and ad qualities, or even budgets of different advertisers. Among many variations of ad ranking and pricing schemes, most are based on rank-by-price and pay-per-click. In this mechanism, assuming that bidding prices are sorted in decreasing order (b₁≧b₂≧ . . . ≧bₙ), bidder i obtains position i, and is charged a fee pᵢ=bᵢ₊₁ whenever a user clicks on its advertisement. No matter what ranking and pricing scheme the auctioneer deploys, for a fixed advertiser and a fixed keyword, the advertiser can obtain any position with an appropriate bidding price. For each advertisement slot, the advertiser incurs a cost (the fee that the auctioneer charges for each user click), obtains a revenue (the expected value-per-click), and a profit (the difference between revenue and cost). Naturally, we can model each ad position as an item with associated weight (cost) and value (either revenue or profit, let us focus on profit for simplicity).

A typical advertiser has a budget for some time horizon (e.g. daily, weekly, quarterly or annually) and wants to purchase a certain set of keywords to maximize its total ROI. The profit of the advertiser is equal to the total amount of expected revenue from search marketing minus the total amount of marketing cost. We can discretize the time horizon into small time periods and assume that the bidding prices of all advertisers do not change over each small time period. Formally, we can model the bidding optimization problem as a multiple-choice knapsack problem as follows. Given multiple keywords k ∈ K, multiple time periods t ∈ {1, . . . , T}, multiple positions s Å {1, . . . , S}, the item-set Nₜ^{k} consists of multiple items corresponding to all the positions. For keyword k, time t, the item-set Nₜ^{k} consists of items (wₜₛ^{k} , vₜₛ^{k}) for all ad positions s. Formally wₜₛ^{k} and vₜₛ^{k} are defined as follows:

wₜₛ^{k}=pₜₛ^{k}α^{k}(s)X^{k}(t) (Eqn. 3)

vₜₛ^{k}=(V^{k}−pₜₛ^{k})α^{k}(s)X^{k}(t), ∀s, t, k.

Here V^{k} denotes the expected value-per-click for keyword k, X^{k} (t) denotes the number of user queries for keyword k at time period t, and α^{k}(s) denotes the click-through rate (CTR) of position s (the ratio between total user clicks on the ad at s-th slot and the total number of impressions). pₜₛ^{k} =b_{t,s+1}^{k}, i.e. the cost-per-click is equal to the next highest bid. Since most auctioneers enforce a policy that each advertiser can have at most one ad appear on each keyword results page, this corresponds to that at most one item can be taken from Nₜ^{k}. If we treat each Nₜ^{k} as an item-set, then this consists of an instance of MCKP where the knapsack capacity C is equal to the advertiser's budget B.

Experimental Results

We run two sets of experiments. The first set evaluates the performance of the algorithm ALG-Online-MCKP on synthetic datasets when items are generated from various probability distributions. The second set of experiments uses a real dataset we manually collected from the (now defunct) Yahoo!/Overture view bids webpage.

Exemplary embodiments provide methods for Online-MCKP that combines an approximation to MCKP with an algorithm for Online-KP. One exemplary method is based on the idea that MCKP can be converted to KP, which can then be solved using a greedy KP approximation, and the solution to KP can be mapped back to the solution to MCKP. The method accomplishes this for the online version of MCKP. The threshold function for KP filters out the items of insufficient efficiency. We adapt the process of computing the threshold function to the online setting where no information about the items needs to be available a priori. Instead, the threshold function is updated online. We apply the method to problem instances generated with different distributions and to a real data set. In all of our experiments the performance is within 10% of the offline optimum, and it approaches the offline optimum when the number of periods is sufficiently large.

Exemplary embodiments are not limited to advertising, but can be used in various non-advertising embodiments. By way of example, such non-advertising embodiments include stock trading and procurement auctions. For example, given a budget and a fixed time period, a goal would be to purchase as many shares of an underlying stock as possible with a given budget. Variations of this example also apply to commodity trading, such as trading of future contracts like oil, metal, meat, agricultural product, etc. As another example, exemplary embodiments can be applied to procurement auctions where the goal is to acquire a designated number of units of a commodity product/component, while the unit price of the commodity product changes over time.

In one exemplary embodiment, one or more blocks in the flow diagrams are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The flow diagrams in accordance with exemplary embodiments are provided as examples and should not be construed to limit other embodiments within the scope of embodiments. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the exemplary embodiments.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term tangible storage media of some type, such as a CD-ROM drive or hard drive. The software programming code is embodied or stored on any of a variety of known tangible storage media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various exemplary embodiments. Numerous variations and modifications will become apparent to those skilled in the art once the above disclosure is fully appreciated. It is intended that the following claims be interpreted to embrace all such variations and modifications.

What is claimed is:

1) A method, comprising:
obtaining bidding prices for different positions at an online search auction;
using a threshold function to decide which position to bid on where a threshold function depends on multiple parameters including an expected value-per-click for a corresponding keyword, budget remaining, and time periods remaining at the online search auction; and
outputting winning slots.

2) The method of claim 1 further comprising:
receiving bids for advertising slots;
displaying advertisements of winning bidders;
transforming a set of training item-sets into a collection of incremental items to compute an approximation of the threshold function.

3) The method of claim 1 further comprising, updating the threshold function online as new sets of incremental items are presented.

4) The method of claim 1, wherein the threshold function is generated using a distribution of items that are independently and identically distributed (iid).

5) The method of claim 1 further comprising, calculating an optimal amount of money to bid for advertising based on modeling keyword bidding as a stochastic Online Multiple-Choice Knapsack Problem (online MCKP).

6) A tangible computer-readable storage medium having computer-readable program code embodied therein for causing a computer system to perform:
obtaining bidding prices for advertising slots for a network search query;
generating a threshold function using a distribution of items that are independently and identically distributed (iid);
using the threshold function to determine an amount to bid for one of the advertising slots; and
outputting advertisements of bidders.

7) The tangible computer-readable storage medium of claim 6, wherein the code further causes the computer system to perform: mapping an average remaining capacity per time period to an efficiency value such that an expected weight of the remaining items with efficiency at least of the efficiency value is equal to the remaining capacity.

8) The tangible computer-readable storage medium of claim 6, wherein the code further causes the computer system to perform: generating the threshold function from training item-sets.

9) The tangible computer-readable storage medium of claim 8, wherein the code further causes the computer system to perform: modeling of a multiple-choice knapsack problem based on one of maximizing a total revenue of an advertiser over time and maximizing a total profit of the advertiser.

10) The tangible computer-readable storage medium of claim 8, wherein the code further causes the computer system to perform: updating budget remaining and the threshold function.

11) A computer system, comprising:
memory storing an algorithm; and
processor to execute the algorithm to:
examine bids for advertising slots for a keyword search;
use a threshold function to submit a bid amount for the advertising slots, the bid amount being a function of an expected value-per-click, remaining budget, and remaining time period;
allocate the advertising slots to bidders.

12) The computer system of claim 11, wherein the threshold function is generated using a distribution of items that are independently and identically distributed (iid).

13) The computer system of claim 11, wherein the processor further executes the algorithm to:
model an online trading process of goods or services, wherein a trader has a budget constraint as an online knapsack problem;
solve an online trading problem using an algorithm developed for the online knapsack problem.

14) The computer system of claim 11 wherein the processor further executes the algorithm to: calculate an optimal amount of money to bid for the advertising based on a multiple-choice knapsack problem modeling of ad slots over time periods.

15) The computer system of claim 11 wherein the processor further executes the algorithm to: updating budget remaining and the threshold function.
